(19) United States
(12) Patent Application Publication
(10) Pub. No.: US 2026/0067809 A1
(43) Pub. Date: Mar. 5, 2026

(54) SYSTEM, METHOD AND APPARATUS FOR STATION-BASED TERMINATION OF A TARGET WAKE TIME SERVICE PERIOD

(71) Applicant: Silicon Laboratories Inc., Austin, TX (US)

(72) Inventors: Ram Krishna Poricha, Hyderabad (IN); Krishna Babu Pedda, Hyderabad (IN); Atul Joshi, Hyderabad (IN)

(21) Appl. No.: 18/818,496

(22) Filed: Aug. 28, 2024

(51) Int. Cl. H04W 52/02

(52) U.S. Cl. CPC H04W 52/0229

(57) ABSTRACT

In one embodiment, a method includes: sending, from a station to an access point, a notification of a termination of a service period in which the station is awake, the notification comprising a station-based initiation of the termination of the service period, the station and the access point present within a wireless local area network; receiving, in the station from the access point, an acknowledgement of the notification; and in response to the acknowledgement, terminating the service period.

### BACKGROUND

One common wireless network is a wireless local area network (WLAN), such as in accordance with a given IEEE 802.11 specification in which various devices, referred to as stations (STAs), communicate via an access point (AP), a special type of STA that manages the network.

Target Wake Time (TWT) operation allows an AP to manage activity in a basic service set (BSS) in order to minimize contention between STAs and to reduce the required amount of time that a STA utilizing a power management mode needs to be awake. A TWT Service Period (SP) refers to a time frame where a STA remains awake to transmit and/or receive frames. A TWT Requesting/Scheduled STA is a STA that requests a TWT agreement from an AP. In turn, a TWT Responding/Scheduling STA (AP) is a STA, namely an AP, that responds to TWT agreement requests. While TWT operation can reduce power consumption of a station, there are still complexities involved, and optimal power savings still may not be achieved.

### SUMMARY OF THE INVENTION

In one aspect, a method includes: sending, from a station to an access point, a notification of a termination of a service period in which the station is awake, the station and the access point present within a wireless local area network; receiving, in the station from the access point, an acknowledgement of the notification; and in response to the acknowledgement, terminating the service period.

In one implementation, terminating the service period comprises causing radio circuitry of the station to enter into a low power mode. The method may also include causing the radio circuitry to enter into the low power mode prior to a previously scheduled end of the service period, the service period comprising a target wake time service period. Terminating the service period may include switching radio circuitry of the station to another wireless protocol for communication of a message via another wireless network.

In an implementation, the method further comprises sending the notification of the termination comprising an Action frame. Sending the Action frame may include a target wake time management action field. The method may further comprise sending the notification of the termination in response to identification of a condition within the station. The condition may be identification of a lack of data communication with the access point for at least a threshold time duration. The condition may be an indication of a high priority message for another wireless communication protocol.

In another aspect, a wireless station includes: at least one transceiver to transmit and receive radio frequency (RF) signals; and a baseband processor coupled to the at least one transceiver to process baseband signals. The baseband processor, during a target wake time (TWT) mode of operation, is to: send, via the at least one transceiver, a notification of a termination of a TWT service period to an access point of a wireless local area network; receive an acknowledgement of the notification from the access point; and after receipt of the acknowledgement, terminate the TWT service period.

In an implementation, after termination of the TWT service period, the at least one transceiver is to enter into a low power mode. After termination of the TWT service period, the at least one transceiver is to switch to another wireless protocol for communication of a message via a different wireless network. The baseband processor may send the notification of the termination in response to an indication of the message comprising a high priority message for the different wireless network. The wireless station may send an Action media access control (MAC) frame comprising the notification of the termination of the TWT service period. The Action MAC frame may have a category field having a TWT management code and an action field having a predetermined value to indicate the termination of the TWT service period.

In an implementation, the baseband processor is to send the notification of the termination in response to a duration in which no data communication with the access point has occurred that exceeds a threshold time duration. The wireless station is to: perform a negotiation with the access point regarding the TWT mode of operation and enter into the TWT mode of operation having at least a minimum TWT wake duration comprising the TWT service period; and after the receipt of the acknowledgement, terminate the TWT service period during the minimum TWT wake duration.

In yet another aspect, a method comprises: sending, from a wireless device to an access point, a notification of a termination of a service period in which the wireless device is awake, the wireless device and the access point present within a wireless local area network; receiving, in the wireless device from the access point, an acknowledgement of the notification; and after receiving the acknowledgement, terminating the service period and causing at least a transceiver of the wireless device to enter into a low power mode.

In an implementation, the method further comprises: performing a negotiation with the access point regarding a TWT mode of operation; entering into the TWT mode of operation having at least a minimum wake duration comprising the service period; and after receiving the acknowledgement, terminating the service period during the minimum wake duration. The method may further include sending the notification of the termination based at least in part on an absence of communication between the wireless device and the access point for at least a threshold time duration, the notification comprising an Action media access control frame to indicate the termination of the service period.

### BRIEF DESCRIPTION OF THE DRAWINGS

FIG. 1 is a timing diagram illustrating operation in accordance with an embodiment.

FIG. 2 is a flow diagram of a method in accordance with an embodiment.

FIG. 3 is a flow diagram of a method in accordance with another embodiment.

FIG. 4 is a block diagram of a management Action media access control frame in accordance with an embodiment.

FIG. 5 is a block diagram of a representative integrated circuit in accordance with an embodiment.

### DETAILED DESCRIPTION

In various embodiments, a wireless device, namely a station, is configured to notify an access point (AP) in a basic service set (BSS) that it intends to terminate a service period during target wake time (TWT) operation. In this way, a station can extend a duration of inactivity during a TWT wake interval (and during this inactive duration, may enter into a given low power mode). As a result, the station may reduce its power consumption and/or enable a switch of radio circuitry to another wireless protocol, in cases where the station is a multi-protocol device.

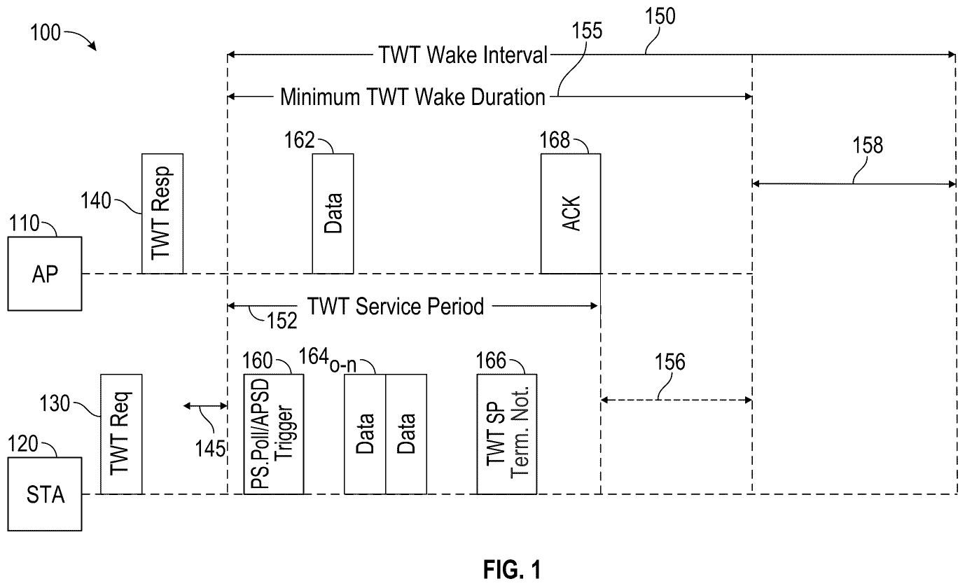

Referring now to FIG. 1, shown is a timing diagram illustrating operation in accordance with an embodiment. As shown in FIG. 1, in a wireless environment 100, which may be a wireless local area network (WLAN) that operates according to an IEEE 802.11 specification, an access point 110 and a station 120 are present. Of course, many other wireless devices may be present within wireless environment 100 (each of which can be another station within the network). For purposes of discussion, assume that station 120 is a wireless device that can communicate in the WLAN such as a smartphone, tablet computer, Internet of Things (IoT) device or other wireless-enabled apparatus. In turn, AP 110 may be a wireless access point such as a router or any other wireless device capable of operation as an access point in the WLAN.

Still referring to FIG. 1, station 120 requests target wake time operation by sending a TWT request 130 to access point 110. In response to this request, the devices enter into a negotiation to negotiate TWT parameters of a TWT agreement. This TWT agreement specifies the details of a TWT session that the station belongs to, including wake-up times and intervals. As shown in FIG. 1, the negotiation results in a TWT agreement that identifies a time period for a TWT wake interval, illustrated in FIG. 1 as TWT wake interval 150, and a minimum TWT wake duration 155 within wake interval 150. Typically, minimum TWT wake duration 155 is a time period during which station 120 is to remain in an awake mode to be available for communication.

Although embodiments are not limited in this regard, wake interval 150 may be on the order of seconds to hours, while minimum wake duration 155 may be on the order of milliseconds (ms) (e.g., 30-50 ms). Although embodiments are not limited in this regard, parameters of these durations are determined based at least in part on conditions within wireless environment 100, e.g., number of stations, application requirements of station 120, and so forth. In other cases, these durations may be fixed according to predetermined values.

After determining these time durations, AP 110 sends a TWT response 140, which identifies these time durations, so that station 120 can configure itself to operate according to these durations. After such configuration, station 120 can enter into a low power mode, such as a doze mode 145, until a first TWT wake interval 150 begins. Note that during doze mode 145, at least radio circuitry such as a multi-protocol transceiver can be disabled (assuming other protocols are not active), thus reducing power consumption. In some implementations, additional circuitry of station 120 also may be placed in a low power mode.

Thus as shown further in FIG. 1, in the case of an announced TWT, station 120 sends an indication 160 (e.g., PS-Poll, QoS Null, Trigger frame etc.) at the beginning of a TWT service period 152 to inform AP 110 that it is ready to receive data. At a beginning of TWT wake interval 150, radio circuitry of station 120 is in an awake mode and enters TWT service period 152. In response, AP 110, which waits for this explicit indication, sends data 162 and station 120 also communicates data to AP 110 (164₀₋ₙ) within TWT service period 152. Note that in the case of an unannounced TWT, AP 110 can start sending data to station 120 within TWT service period 152 without waiting for any explicit indication from station 120.

As further shown in FIG. 1 during TWT service period 152 within minimum TWT wake duration 155, station 120 issues a TWT service period termination notification 166. In response to this message, AP 110 sends an acknowledgement 168, after which TWT service period 152 concludes, and no further communications are sent from AP 110 to station 120 during wake interval 150.

Thus in response to receipt of acknowledgement 168, station 120 enters an extended power save window 156. As illustrated, extended power save window 156 is within minimum TWT wake duration 155, thus effectively extending a time in which station 120 may place the device including radio circuitry into a low power mode and/or switch the radio circuitry to operate according to another wireless protocol. Following minimum TWT wake duration 155, a power save window 158 exists, which is entered naturally without a TWT service period termination requested by station 120 when minimum TWT wake duration 155 ends and no further data is to be communicated between the devices.

When early TWT service period termination is requested by station 120, power save window 158 is effectively extended by the duration of extended power save window 156. When TWT service period termination is not invoked by station 120 and should no further data be available for communication between the devices, station 120 may place radio circuitry into a low power mode (and/or switch the radio circuitry to another wireless protocol) for power save window 158, without a further communication between the devices.

Although shown at this high level in the embodiment of FIG. 1, understand that variations and alternatives are possible. For example, while in the above discussion only a WLAN is described, understand that wireless environment 100 may include additional wireless networks such as personal area networks, piconets, and so forth. In such instances, station-based TWT service period termination may be initiated due to activity (e.g., a high priority message) of one or more of these other wireless networks.

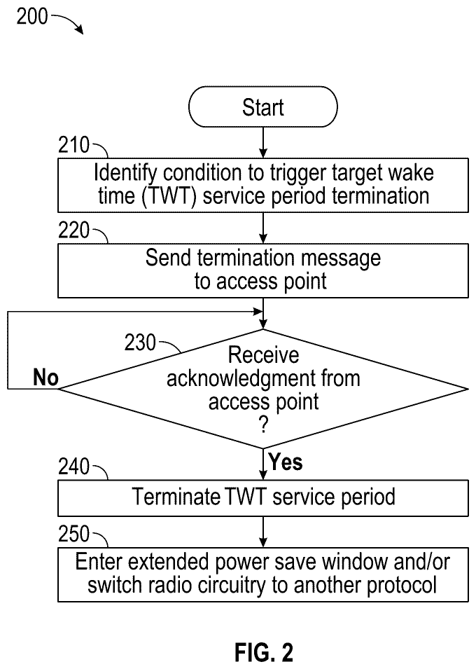

Referring now to FIG. 2, shown is a flow diagram of a method in accordance with an embodiment. As shown in FIG. 2, method 200 is a method for terminating a TWT service period by a station in accordance with an embodiment. As such, method 200 may be performed by hardware circuitry of the station, alone and/or in combination with firmware and/or software. As illustrated, method 200 begins by identifying a condition to trigger a TWT service period termination (block 210). Although embodiments are not limited in this regard, this condition may be based on identification of at least a threshold amount of time during which no data communication between station and AP has occurred, or on an indication from an arbiter, e.g., of a host processor of the station, indicating that a high priority communication is to occur for another protocol of a multi-protocol device.

In any case, responsive to this identification of such condition, control passes to block 220 where a termination message is sent to the access point. In an embodiment, this termination message may be sent as a TWT service period termination notification. Different manners of providing this notification may occur in different implementations. For example, a given IEEE 802.11 specification may provide a special code for this notification, or a vendor-defined message can be sent. Note also that in particular implementations, this message may be in the form of a notification, rather than a request. As such, the station can be in control of the initiation of a TWT service period termination.

Still referring to FIG. 2, control next passes to diamond 230, where it is determined whether an acknowledgment has been received from the access point. Note that this acknowledgement is simply an acknowledgement of receipt of the termination message, rather than an affirmative granting of the termination by the AP, as in this instance the station itself initiates the TWT service period termination. Next, at block 240, the TWT service period is terminated, such that no further communications occur between station and AP during this particular TWT wake interval.

Accordingly, control passes to block 250. Here, the station may enter into an extended power save window and/or switch radio circuitry to another protocol (e.g., a Bluetooth protocol). Note that the extended power save window thus enables greater power savings within the station. With further reference back to FIG. 1, this extended power save window reduces the awake mode duration of the station in a minimum TWT wake duration. Although shown at this high level in the embodiment of FIG. 2, understand that many variations and alternatives are possible.

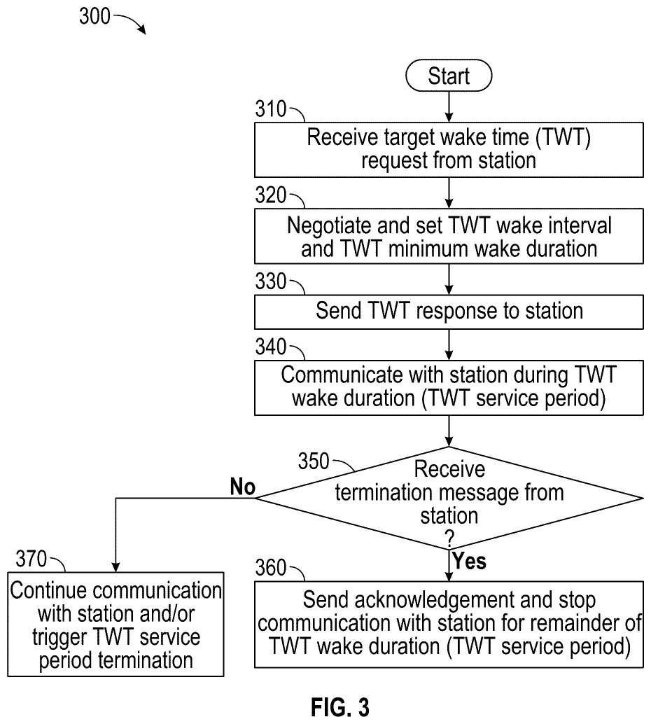

Referring now to FIG. 3, shown is a flow diagram of a method in accordance with another embodiment. More specifically, in FIG. 3, method 300 is a method for managing TWT operations via an AP in accordance with an embodiment. As such, method 300 may be performed by hardware circuitry of the AP, alone and/or in combination with firmware and/or software.

As illustrated, method 300 begins by receiving a TWT request from a station (block 310). Note that this TWT request is from a station that seeks to operate in a TWT mode so that it can reduce power consumption. Next at block 320, the AP and station enter into a negotiation in which a TWT wake interval and a TWT minimum wake duration are set. In one or more embodiments, these time durations may be based on network conditions such as the number of stations present in a WLAN, application requirements of the station and so forth. Next at block 330, the AP sends a TWT response to the station. Understand that this TWT response may identify the duration of the TWT wake interval and the TWT minimum wake duration.

With this information, the AP and the station are appropriately configured for operation in a TWT mode. Thus at block 340, the AP may communicate with the station during a TWT wake duration (i.e., during a TWT service period). While in this duration, it may be determined at diamond 350 whether a termination message is received from the station. If so, control passes to block 360, where the AP sends an acknowledgement to the station. Understand that after communication of the acknowledgement, the AP stops communicating with the station for the remainder of the TWT wake duration (and of course, the AP does not communicate during a standard power save window following a minimum TWT wake duration).

Still referring to FIG. 3, in the absence of a termination message, control passes to block 370 where continued communications may occur between the AP and the station during the TWT service period. It is possible that during this TWT service period, the AP itself may determine to terminate the TWT service period, e.g., due to a lack of data for communication to the station. Although shown at this high level in the embodiment of FIG. 3, many variations and alternatives are possible.

As described above, a station can inform an AP regarding TWT service period termination via a notification message. Depending on implementation, there can be different manners of communicating this notification message. In one or more implementations, a station can send a notification via an Action media access control (MAC) frame. In one example, a wireless protocol specification, e.g., a given IEEE 802.11 specification, can be extended to provide a defined Action MAC frame for TWT management.

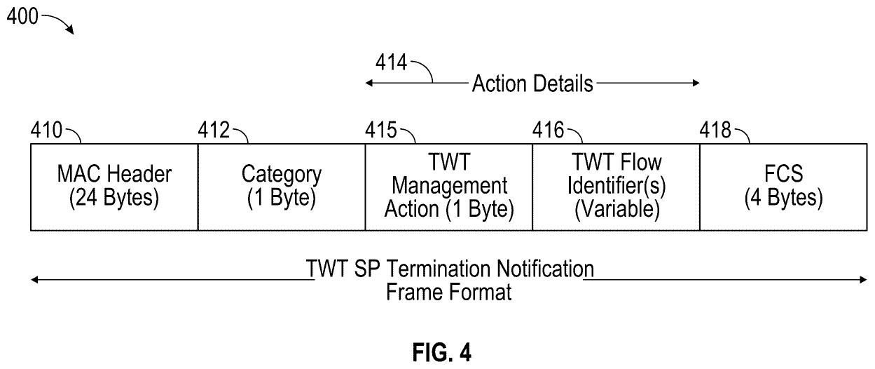

Referring now to FIG. 4, shown is a block diagram of a TWT management Action MAC frame in accordance with an embodiment. As shown in FIG. 4, Action MAC frame 400 is a TWT management Action MAC frame having a plurality of fields. MAC frame 400 includes a MAC header field 410 having 24 bytes, and which is followed by a category field 412 (e.g., a single byte). Then frame 400 includes action details 414 including a TWT management action field 415 and a TWT flow identifier field 416. In an embodiment, TWT management action field 415 may be a 1 byte field having a value to indicate a TWT service period termination notification.

Where a specification defines station-based TWT service period termination, category field 412 may have a predetermined value (e.g., 38) to identify Action MAC frame 400 as a TWT management Action frame. And in turn, TWT management action field 415 can have a different predetermined value (e.g., 0) to provide the TWT service period notification (with other possible values reserved for future extensions).

Still referring to FIG. 4, TWT flow identifier field 416 may be a variable width and can be used to indicate different TWT sessions running in parallel. Finally, frame 400 ends with a frame check sequence (FCS) field 418, which is calculated over header 410 and the remainder of frame 400.

Instead when there is not a specified code for a TWT management Action MAC frame, a vendor-defined message may be sent as a termination notification. In such examples, the category field of the frame can be sent with a vendor-specific value to identify the frame as a vendor-defined message (and with a corresponding action field and/or flow identifier field to indicate the termination message).

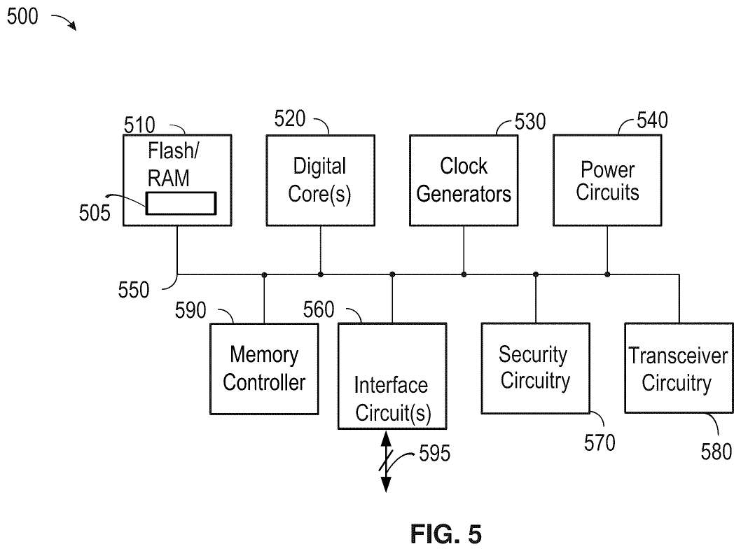

Embodiments can be implemented in a variety of wireless device use cases. Referring now to FIG. 5, shown is a block diagram of a representative integrated circuit 500 that includes transceiver circuitry, as described herein. In the embodiment shown in FIG. 5, integrated circuit 500 may be, e.g., a multi-mode wireless transceiver that may operate according to multiple wireless protocols (e.g., Wi-Fi and Bluetooth, among others) or other device that can be used in a variety of use cases, including stations and access points as described herein (and which may be incorporated into access point 110 and/or station 120 of FIG. 1). In one or more embodiments, the circuitry of integrated circuit 500 may be implemented on a single semiconductor die or implemented on separate dies for wireless communication.

Integrated circuit 500 may be included in a range of devices, but for purposes of discussion, assume incorporation into an access point and/or station. In the embodiment shown, integrated circuit 500 includes a memory system 510 which in an embodiment may include volatile storage, such as RAM and non-volatile memory such as a flash memory. The flash memory is a non-transitory storage medium that can store instructions and data. In embodiments, this storage may store TWT management code 605 that can enable and configure the device for station-based TWT service period termination initiation (and additional TWT operations including TWT mode configuration, operation, and access point-based TWT terminations), as described herein. As further shown integrated circuit 500 also may include a memory controller 590.

Memory system 510 couples via a bus 550 to one or more digital cores 520, which may include one or more cores and/or microcontrollers that act as processing units of the integrated circuit, and which may perform TWT management operations. In turn, digital cores 520 may couple to clock generators 530 which may provide one or more phase locked loops or other clock generator circuitry to generate various clocks for use by circuitry of the IC.

As further illustrated, IC 500 further includes power circuitry 540. Additional circuitry may be present depending on particular implementation to provide various functionality and interaction with external devices. Such circuitry may include interface circuitry 560 which provides a digital communication interface with additional circuitry. IC 500 also may include security circuitry 570 to perform wireless security techniques.

In addition, as shown in FIG. 5, transceiver circuitry 580 may be provided to enable transmission and reception of wireless signals, e.g., according to one or more of a local area or wide area wireless communication scheme, such as Zigbee, Bluetooth, IEEE 802.11, IEEE 802.15.4, cellular communication or so forth. Understand while shown with this high level view, many variations and alternatives are possible.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
sending, from a station to an access point, a notification of a termination of a service period in which the station is awake, the station and the access point present within a wireless local area network;
receiving, in the station from the access point, an acknowledgement of the notification; and
in response to the acknowledgement, terminating the service period.

2. The method of claim 1, wherein terminating the service period comprises causing radio circuitry of the station to enter into a low power mode.

3. The method of claim 2, further comprising causing the radio circuitry to enter into the low power mode prior to a previously scheduled end of the service period, the service period comprising a target wake time service period.

4. The method of claim 1, wherein terminating the service period comprises switching radio circuitry of the station to another wireless protocol for communication of a message via another wireless network.

5. The method of claim 1, further comprising sending the notification of the termination comprising an Action frame.

6. The method of claim 5, further comprising sending the Action frame comprising a target wake time management action field.

7. The method of claim 1, further comprising sending the notification of the termination in response to identification of a condition within the station.

8. The method of claim 7, wherein the condition comprises identification of a lack of data communication with the access point for at least a threshold time duration.

9. The method of claim 7, wherein the condition comprises an indication of a high priority message for another wireless communication protocol.

10. A wireless station comprising:
at least one transceiver to transmit and receive radio frequency (RF) signals; and
a baseband processor coupled to the at least one transceiver to process baseband signals, wherein the baseband processor, during a target wake time (TWT) mode of operation, is to:
send, via the at least one transceiver, a notification of a termination of a TWT service period to an access point of a wireless local area network;
receive an acknowledgement of the notification from the access point; and
after receipt of the acknowledgement, terminate the TWT service period.

11. The wireless station of claim 10, wherein after termination of the TWT service period, the at least one transceiver is to enter into a low power mode.

12. The wireless station of claim 10, wherein after termination of the TWT service period, the at least one transceiver is to switch to another wireless protocol for communication of a message via a different wireless network.

13. The wireless station of claim 12, wherein the baseband processor is to send the notification of the termination in response to an indication of the message comprising a high priority message for the different wireless network.

14. The wireless station of claim 10, wherein the wireless station is to send an Action media access control (MAC) frame comprising the notification of the termination of the TWT service period.

15. The wireless station of claim 14, wherein the wireless station is to send the Action MAC frame comprising a category field having a TWT management code and an action field having a predetermined value to indicate the termination of the TWT service period.

16. The wireless station of claim 10, wherein the baseband processor is to send the notification of the termination in response to a duration in which no data communication with the access point has occurred that exceeds a threshold time duration.

17. The wireless station of claim 10, wherein the wireless station is to:
perform a negotiation with the access point regarding the TWT mode of operation and enter into the TWT mode of operation having at least a minimum TWT wake duration comprising the TWT service period; and
after the receipt of the acknowledgement, terminate the TWT service period during the minimum TWT wake duration.

18. A storage medium comprising instructions that when executed cause a wireless device to perform a method comprising:
sending, from the wireless device to an access point, a notification of a termination of a service period in which the wireless device is awake, the wireless device and the access point present within a wireless local area network;
receiving, in the wireless device from the access point, an acknowledgement of the notification; and
after receiving the acknowledgement, terminating the service period and causing at least a transceiver of the wireless device to enter into a low power mode.

19. The storage medium of claim 18, wherein the method further comprises:
performing a negotiation with the access point regarding a target wake time (TWT) mode of operation;
entering into the TWT mode of operation having at least a minimum wake duration comprising the service period; and
after receiving the acknowledgement, terminating the service period during the minimum wake duration.

20. The storage medium of claim 18, wherein the method further comprises sending the notification of the termination based at least in part on an absence of communication between the wireless device and the access point for at least a threshold time duration, the notification comprising an Action media access control frame to indicate the termination of the service period.
